(19) United States
(12) Patent Application Publication
(10) Pub. No.: US 2007/0240372 A1
(43) Pub. Date: Oct. 18, 2007

(54) Window area

(76) Inventors: Bernhard Buhlmann, Zurich (CH); Peter Eugster, Weiningen (CH); Urs Frei, Zurich (CH)

Correspondence Address: ABELMAN, FRAYNE & SCHWAB, 666 THIRD AVENUE, 10TH FLOOR, NEW YORK, NY, 10017, US

(21) Appl. No.: 11/728,323

(22) Filed: Mar. 23, 2007

(30) Foreign Application Priority Data
Mar. 29, 2006 (EP) EP06405132

(51) Int. Cl. E06B 7/10

(52) U.S. Cl. 52/209; 52/302.7

(57) ABSTRACT

Next to a window opening (4) an inlet air pipe (14) and an exit air pipe (17) are arranged vertically a distance apart in an outer insulation (1), each of which connect an outer inlet air opening (15) and an outer exit air opening (18), respectively, to an inner inlet air opening (13) and an inner exit air opening (16), respectively, which are located in a depression (12) of a cladding (9) into which a fan (19) is inserted with a back. It connects the inner inlet air opening (13) via an inlet air channel to an inlet air outlet (21) and the inner exit air opening (16) via an exit air channel, which, together with the inlet air channel, forms a heat exchanger, to an exit air entrance (22). The exit air entrance (22) and the inlet air outlet (21) are arranged one on top of the other and a distance apart on the front of the fan (19). Instead of the fan (19), a closure plate (23) can also be inserted into the depression (12).

### A. BACKGROUND

1. Field of the Invention

The invention relates to a window area such as window areas which occur in exterior walls of buildings of all kinds, especially residential and office buildings.

2. Prior Art

Window areas of the generic type are generally known.

### B. OBJECTS AND SUMMARY OF THE NEW INVENTION

It is the object of the invention to open up the possibility of arranging in the window area an air exchange device which removes inlet air from a closed room and supplies exit air from the outside, in particular a fan, in which preferably heat is exchanged between inlet air and exit air for causing the temperature of the former to approach room temperature.

### C. BRIEF DESCRIPTION OF THE DRAWINGS

Below, the invention is explained in more detail with reference to figures which show only an embodiment.

FIG. 1 shows a window area according to the invention from the inside,

FIG. 2 shows a horizontal section through the window area according to FIG. 1,

FIG. 3 shows a vertical section through the window area according to FIGS. 1, 2,

FIG. 4 shows a horizontal section according to FIG. 2 through a modified window area according to the invention and

FIG. 5 shows a vertical section according to FIG. 3 through the modified window area of FIG. 4.

### D. DETAILED DESCRIPTION OF THE PREFERRED EMBODIMENTS

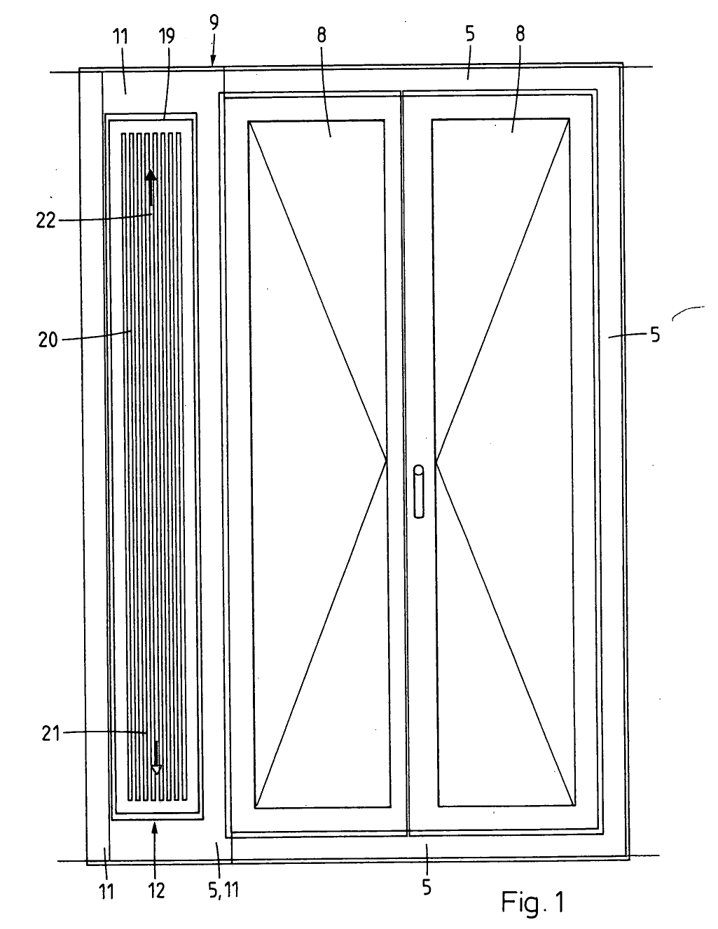

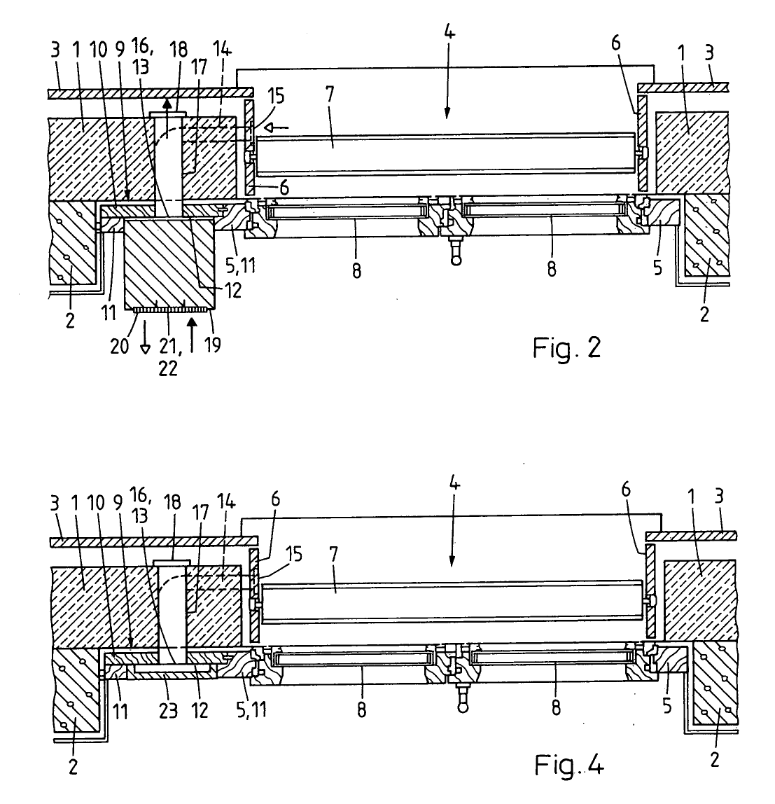

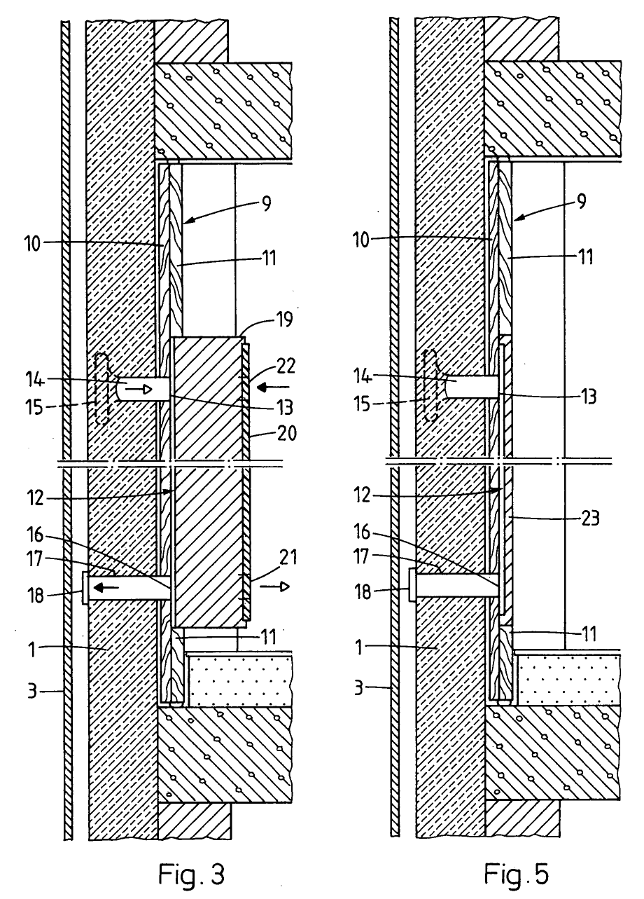

The window area according to the invention comprises (FIG. 1-3) an outer insulation 1 which preferably consists of a solid heat-insulating material, such as, for example, comprising Styropor or mineral wool, and forms a substantially continuous vertical layer which covers the facade, is a constant thickness, is usually arranged on the outside of a wall 2 comprising, for example, brickwork or concrete, and is covered on the outside by an outer cladding 3 arranged in front a small distance away, ventilated at the back and consisting, for example, of wood, natural stone or aluminium. Cut out of the outer insulation 1 is a rectangular window opening 4 in which is arranged a window frame 5 which frames the window opening 4 on the inside. In the area of a reveal 6 surrounding the window opening 4, the outer insulation 1 is likewise concealed by the outer cladding 3 in which a roller blind 7 is guided there. Two window casements 8 which can be swivelled inwards are attached to the window frame 5.

A narrow, likewise rectangular cladding 9 which covers the inside of the outer insulation 1 between the window frame 5 and the wall 2 cut out slightly further than the outer insulation 1 is mounted next to the window frame 5. The cladding 9 comprises a plate 10 and a frame 11 which partially surrounds and partly covers said plate, projects slightly all round, may coincide with a lateral part of the window frame 5 and surrounds a shallow rectangular depression 12, the bottom of which is formed by the plate 10. The window frame 5 and the cladding 9 may consist of wood.

In the vicinity of the upper end of the depression 12, an inner inlet air opening 13 is arranged in the plate 10, adjacent to which inlet air opening is an inlet air pipe 14 which leads horizontally and with a 90° bend through the outer insulation 1 to a slot-like outer inlet air opening 15 in the outer cladding 3 at the reveal 6. In the vicinity of the lower end of the depression 12, i.e. vertically a distance away from the inner inlet air opening 13, a corresponding inner exit air opening 16 is arranged in the plate 10, from which exit air opening an exit air pipe 17 leads horizontally and straight through the outer insulation 1 to an outer exit air opening 18 on the outside thereof. The exit air pipe 17 thus opens into the gap between the outer insulation 1 and the outer cladding 3.

A fan 19 having a cuboid housing of approximately square contour, the height of which corresponds completely or approximately to that of the window casement 8, is inserted with an exact fit into the depression 12. The said fan has, on its back located in the depression 12, an inlet air entrance which coincides with the inner inlet air opening 13 and an exit air outlet which coincides with the exit air opening 16. On the front, it has, behind a grille 20, an inlet air outlet 21 which is at about the height of the exit air outlet and, above this, i.e. vertically offset, an exit air entrance 22 approximately at the height of the inlet air entrance. The exit air entrance 22 of the fan 19 is connected to the exit air outlet by an exit air channel which, together with an inlet air channel connecting the inlet air entrance to the inlet air outlet 21, forms a heat exchanger. At least one of the two channels is provided with a ventilator which generates an air flow from the entrance to the outlet so that fresh air is sucked in via the inlet air pipe 14 at the outer inlet air opening 15 and is finally released into the room at the inlet air outlet 21, while exit air is removed from the room through the exit air entrance 22 and fed via the exit air pipe 17 to the outer exit air opening 18 and released there to the outside. Numerous fans which can be used here are known. For example, the fan 19 can be substantially designed like the ventilation device described in EP 1 510 764 A1, it being necessary at most to carry out adaptations relating to the position of the entrances and outlets by supplementing or modifying the inlet air and the exit air channel.

By vertical shifting of the inlet air outlet 21 and of the exit air entrance 22, undesired mixing, i.e. immediate removal again of a part of the inlet air just introduced, is reduced to a degree which is not troublesome. On the outside, the outer inlet air opening 15 and the outer exit air opening 18 are separated not only by the vertical shifting but also by virtue of the fact that the former is mounted in the outer cladding 3 in the area of the reveal 6 and the latter is located behind the outer cladding 3 on the outside of the outer insulation 1. Mixing of exit air and inlet air which is particularly troublesome in this case—immediate reintroduction, as inlet air, of a part of the exit air just removed—is therefore virtually completely suppressed.

By means of the fan 19, not only is inlet air fed in and exit air removed, the temperature of the inlet air is also caused to approach that of the exit air, i.e. the temperature of the frequently heated or cooled room, and an energy saving which may be considerable in certain circumstances is thus achieved.

If, however, no fan is to be used, it is possible (FIGS. 4, 5) instead simply to insert into the depression 12 an accurately fitting rectangular closure plate 23 which separates the inner inlet air opening 13 and the inner exit air opening 16 from the room. Preferably, the fan 19 and the closure plate 23 are reversibly connectable, e.g. screwable, in the same manner to the cladding 9 so that they can easily be exchanged even after completion of the building.

### LIST OF REFERENCE SYMBOLS

1 Outer insulation
2 Wall
3 Outer cladding
4 Window opening
5 Window frame
6 Reveal
7 Roller blind
8 Window casement
9 Cladding
10 Plate
11 Frame
12 Depression
13 Inner inlet air opening
14 Inlet air pipe
15 Outer inlet air opening
16 Inner exit air opening
17 Exit air pipe
18 Outer exit air opening
19 Fan
20 Grille
21 Inlet air outlet
22 Exit air entrance
23 Closure plate

While the invention has been described in conjunction with several embodiments, it is to be understood that many alternatives, modifications, and variations will be apparent to those skilled in the art in light of the foregoing description. Accordingly, this invention is intended to embrace all such alternatives, modifications, and variations which fall within the spirit and scope of the appended claims.

1. Window area comprising an outer insulation (1) through which a window opening (4) passes and a window frame (5) surrounding the window opening (4) characterized in that an inner inlet air opening (13) and an inner exit air opening (16) are arranged on the inside of the outer insulation (1), laterally adjacent to the window frame (5), each of which are connected by means of an inlet air pipe (14) and exit air pipe (17), respectively, led through the outer insulation (1), to an outer inlet air opening (15) and outer exit air opening (18), respectively, arranged outside the window frame (5).

2. Window area according to claim 1, characterized in that the inner inlet air opening (13) and the inner exit air opening (16) are located in a cladding (9) which is adjacent to the window frame (5) and covers the inside of the outer insulation (1) there.

3. Window area according to claim 2, characterized in that the inner inlet air opening (13) and the inner exit air opening (16) are arranged in a depression (12) of the cladding (9).

4. Window area according to claim 1, characterized in that the inner inlet air opening (13) and the inner exit air opening (16) are vertically a distance apart.

5. Window area according to claim 1, characterized in that the outer inlet air opening (15) is at the reveal (6) of the window opening (4), while the outer exit air opening (18) is at that outside of the outer insulation (1) which is opposite the inside, or vice versa.

6. Window area according to claim 1, characterized in that the inlet air pipe (14) and the exit air pipe (17) are each led horizontally through the outer insulation (1).

7. Window area according to claim 1, characterized in that it comprises a fan (19) arranged next to the window frame (5), having an inlet air entrance adjacent to the inner inlet air opening (13) and an inlet air outlet (21) connected thereto via an inlet air channel, and an exit air outlet adjacent to the inner exit air opening (16) and an exit air entrance (22) connected thereto via an exit air channel, the inlet air channel and the exit air channel forming a heat exchanger.

8. Window area according to claim 7, characterized in that the fan (19) has a ventilator at least in the inlet air channel or in the exit air channel.

9. (canceled)

10. (canceled)

11. Window area according to claim 1, characterized in that inner inlet air opening 13 and the inner exit air opening 16 are located in a cladding 9 which is adjacent to the window frame 5 and covers the inside of the outer insulation 1 there, and further characterized in that the inner air inlet opening 13 and the inner exit air opening 16 are arranged in a depression 12 of the cladding 9, said window area further comprising a fan 19 arranged next to the window frame 5, having an air inlet entrance adjacent to the inner inlet air opening 13 and an inlet air outlet 21 connected thereto via an inlet air channel, and an exit air outlet adjacent to the inner exit air opening 16 and an exit air opening 22 connected thereto via an exit air channel, the inlet air channel and the exit air channel forming a heat exchange.

12. A window area according to claim 11, characterized in that the fan 19 has a ventilator at least in the inlet air channel or in the exit air channel.

13. A window area according to claim 7, characterized in that the air outlet 21 and the exit air entrance 22 are arranged vertically a distance apart on a front of the fan 19.

14. A window area according to claim 8, characterized in that the inlet air outlet 21 and the exit air entrance 22 are arranged vertically a distance apart on a front of the fan 19.

15. A window area according to claim 12, characterized in that the inlet air outlet 21 and the exit air entrance 22 are arranged vertically a distance apart on a front of the fan 19.
